(19) United States
(12) Patent Application Publication
(10) Pub. No.: US 2010/0211582 A1
(43) Pub. Date: Aug. 19, 2010

(54) OPEN ARCHITECTURE VEHICLE INFORMATION MODULE FOR VEHICLE AND TRAILER, AND SYSTEM AND METHOD THEREOF

(75) Inventors: Jennifer KOTSKI, Owego, NY (US); Conrad Coffman, Endicott, NY (US); Michael Kane, Endicott, NY (US); John J. Cole, Endwell, NY (US); Patrick Jesse, Binghamton, NY (US); Matthew Leas, Apalachin, NY (US)

Correspondence Address: MILES & STOCKBRIDGE PC, 1751 PINNACLE DRIVE , SUITE 500, MCLEAN, VA, 22102, US

(73) Assignee: LOCKHEED MARTIN CORPORATION, Bethesda, MD (US)

(21) Appl. No.: 12/372,363

(22) Filed: Feb. 17, 2009

(51) Int. Cl. G06F 15/16; G08B 21/00; G06F 17/30

(52) U.S. Cl. 707/756; 340/431; 709/206; 707/E17.005

(57) ABSTRACT

A module, system, and method for presenting vehicle and trailer data to a client. A vehicle information module (VIM) is configured to interpret, store, and communicate to interested clients the status of a vehicle and/or a trailer. Interested clients or end-users may include a GUI, a database, an Interrogative Diagnostics & Prognostics System and other future stakeholders, such as a fleet management system, a logistics system, a maintenance system, and a mobile personal digital assistant.

The present invention relates generally to gathering and sending vehicle and trailer data to clients, and, more particularly, to an open architecture vehicle information module and system and method thereof for gathering and sending vehicle and trailer data to clients.

### BRIEF DESCRIPTION OF THE DRAWINGS

FIG. 1 is a block diagram of an exemplary system according to various embodiments of the present invention;

FIG. 2 is a block diagram illustrating a relationship of a subsystem configured in the vehicle information module;

FIG. 3 is a block diagram illustrating an exemplary relationship of a specific subsystem configured in the vehicle information module;

FIG. 4 is a flowchart of an exemplary method according to various embodiments of the present invention; and

FIG. 5 is a block diagram of a vehicle/trailer combination system according to various embodiments of the present invention.

### DETAILED DESCRIPTION

In one aspect, an exemplary embodiment of the present invention relates to a method for providing specific data to an end-user. The method can comprise selectively interpreting received messages associated with a complex system, receiving a request from an end-user for specific data, and sending to the end-user only the requested data in response to the received request. The selectively interpreting can be based on a configuration of one or more eXtensible Markup Language (XML) files, and the XML files can be reconfigurable based on a physical change made to the complex system. The specific data can be associated with a current status of the complex system. The end-user may be one or more of a graphical user interface, a database, an Interrogative Diagnostics and Prognostics system, a fleet management system, a logistics system, a maintenance system, and a mobile personal display device.

In another aspect, an exemplary embodiment of the present invention relates to a system for presenting specific vehicle and trailer data to a client upon request. The system can comprise means for receiving a first message signal including a trailer status information and means for receiving a second message signal including trailer status information. The first message signal can be in a first data format, and the second message signal can be in a second data format, the second data format being different from the first data format. The system also can comprise means for translating the first message in the first format to a third data format, means for translating the second message in the second format to the third data format, means for receiving a request for trailer status information, and means for transmitting only requested trailer status information, the transmitted trailer status information being transmitted in the third data format.

In another aspect, an exemplary embodiment of the present invention can include a method for presenting vehicle data of a wheeled tactical vehicle and trailer combination vehicle to a client using a vehicle information module of a vehicle management system. The vehicle information module may be configurable through a series of eXtensible Markup Language (XML) files, and the XML files can define device addresses, messages, and desired fields. The method can comprise receiving at the vehicle information module of the vehicle management system, selectively translating the received vehicle messages and the trailer messages into individual data fields using the vehicle information module, receiving a request from a client for vehicle or trailer data, and sending to the client requested vehicle data or the trailer data based on receiving the request, wherein the sending may be via a webservice interface. Vehicle messages can include vehicle data and trailer data, and the requested vehicle or trailer data may include data representing a status of the wheeled tactical vehicle or a status of the trailer. The selective translating may be based on the desired fields specified in the XML files, and the selective translating may be performed such that only vehicle or trailer messages necessary to populate the desired fields specified in the XML files are translated.

Generally, the present invention can involve a vehicle information module (VIM) configured to interpret, store, and communicate to interested clients the status of a system, such as a vehicle. Interested clients or end-users may include a graphical user interface (GUI), a database, an Interrogative Diagnostics & Prognostics System, and other future stakeholders (e.g., fleet management, logistics, maintenance, personal digital assistant, etc.). In operation, the VIM can receive messages or signals transmitted from vehicle systems, subsystems, or devices and interpret data of the messages or signals. In particular, various embodiments of the invention can include transmitting messages or signals via a controller area network (CAN) bus (e.g., J1939 bus) and/or via Ethernet. Typically, diagnostic and prognostic information can be sent via Ethernet. Note, however, that the present invention is not limited to CAN bus and Ethernet, but can be flexible, through class composition, to allow other methods of communication with code extensions to the VIM. Serial communication means may be another example of a means by which messages or signals may be transmitted to the VIM.

The messages or signals can be received by the VIM and translated into individual data fields, for instance, and the individual data fields can be requested by other software modules, such as clients or end-users. Because data must be requested by an end-user or client, the present invention embodies a “pull” model rather than a “push” model—that is to say, the VIM is not concerned with who is interacting with it, only what data is needed.

One or more subsystems, such as electronic control units (ECUs) may be physically arranged on the vehicle. ECUs, for example, may transmit messages from multiple Parameter Group Numbers (PGNs) via the CAN bus. Each PGN can include one or more data fields. The VIM may define a Vehicle object, which can include multiple subsystem (e.g., ECU) objects. Each subsystem may store multiple messages (e.g., PGNs), which can each be composed of one or more data fields.

Often, subsystems on the vehicle, such as ECUs or sensing elements, are swapped out between models and manufacturers. This typically required a change directly to the source code. In the present invention, however, if messages or data fields need to be added, changed, or removed, it may be done through eXtensible Markup Language (XML) files rather than editing source code. Thus, the VIM can be configurable through a series of XML files, in which device addresses, messages, and desired fields are defined. Thus, a user may update, add, or delete a database XML file, and to change the vehicle configuration, the user only has to update the VehicleXmlDefinitions directory, for example, with the correct subsystem or ECU XML files. Furthermore, recompilation may be prevented every time a subsystem or ECU is changed, replaced, removed, or added, or when an XML file is modified or added based on the change, replacement, addition, or deletion. By rebooting the vehicle management system (VMS) computer, the modified or “new” vehicle configuration settings will be available. Alternatively, all of the XML files may be re-read upon knowing or learning that one or more XML files have been modified, added, or deleted.

The vehicle may have more subsystems, messages, and data fields available than are of interest to an end-user or client. The VIM can interpret or translate only the messages necessary to populate the fields specified by the XML files. Interpreting or translating only the messages necessary to populate the fields specified by the XML files can allow for memory and processing resources to be saved. Moreover, use of configurable or reconfigurable XML files also may be advantageous over systems in which all fields are hardcoded for storage, interpretation, and/or communication.

The design of the VIM is such that it mirrors the physical reality of the vehicle. That is to say, the VIM can provide a snapshot of the current state of the vehicle (e.g., state of subsystems, such as ECUs) and clients can access vehicle data via a web service interface, for example. Thus, for the present invention, there can be a single, common interface for clients needing vehicle information. Embodiments of the present invention also include one data format transmitted to all clients. The system and method according to various embodiments of the present invention can provide functions that allow a client or end-user to either obtain a one-time snapshot of the vehicle or subscribe to a set of information, for example. Moreover, clients may request different levels of data. Clients also may request all information for a subsystem, or they may only subscribe to or request individual data fields. The VIM will only send what is asked for.

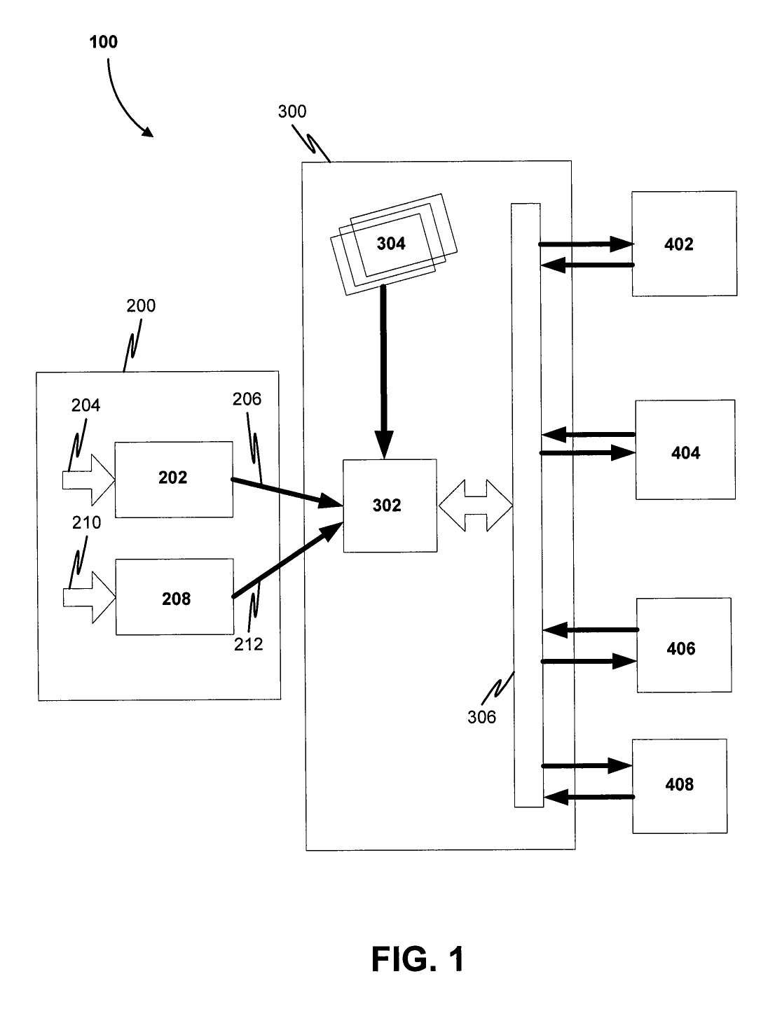

FIG. 1 shows a system 100 according to various embodiments of the present invention. System 100 can have any suitable configuration and can have any suitable components or elements. In various embodiments, system 100 can be implemented in a vehicle (not explicitly shown). The vehicle can be any suitable vehicle, such as a car, a truck, a motorcycle, a hydroplane, a vehicle/trailer combination vehicle, a helicopter, an airplane, a flatbed truck adapted to receive different shelters or modules on its bed, and tactical vehicles (e.g., tanks, helicopters, airplanes, vehicle/trailer combination vehicles, trucks, flatbed trucks, etc.). Furthermore, system 100 can be a networked computer system.

System 100 can include a vehicle data transmitting portion 200, a vehicle management system (VMS) 300, and a plurality of stakeholders or clients 402, 404, 406, 408. Generally speaking, a stakeholder or client may be an end-user of the vehicle data or information. In various embodiments of the present invention, a stakeholder or client must first request system data or information from a vehicle information module (VIM) of the VMS. For example, client 402 may include a graphical user interface (GUI), client 404 may include a database, client 406 may include an Interrogative Diagnostics and Prognostics system, and client 408 may include one of a fleet management system, a logistics system, a maintenance system, and a mobile personal display device. Note that although FIG. 1 shows four clients, there may be any suitable number of clients, and any suitable number of clients may have access.

Vehicle data transmitting portion 200 and VMS 300 can be on-board the vehicle. Similarly, some or all of stakeholders or clients 402, 404, 406, and 408 may be on-board the vehicle. Optionally, some or all of stakeholders or clients 402, 404, 406, and 408 may be off-board and remote from the vehicle.

Vehicle data transmitting portion 200 can be any suitable means by which vehicle data or information, such as status data or information, can be transmitted. Vehicle data transmitting portion 200 can include a first element 202, and, optionally, a second element 208. Generally speaking, elements 202 and 208 can translate or modify received messages or signals into a format the VIM 302 can understand. Note that although FIG. 1 shows only first and second elements 202, 208, the vehicle data transmitting portion may be configured with only the first element 202, with only the second element 208, or with both the first element 202 and the second element 208 and one or more additional elements to translate or modify received messages or signals into a format the VIM 302 can understand.

In various embodiments, first element 202 may be a CAN bus manager, which can receive CAN bus messages via J1939 protocol and J1939 bus 204, for example, and transmit associated messages or signals 206. In various embodiments, the first element 202 can transmit the associated messages or signals 206 to VIM 302. Furthermore, in various embodiments, the first element 202 can translate or modify the received message or signal 204 into a format the VIM 302 can understand.

Second element 208 may be characterized as a subsystem, such as a prognostics module or a diagnostic module. Second element 208 may receive messages or signals 210 from one or more vehicle sensors, for example. In various embodiments, the one or more vehicle sensors can be associated with vehicle prognostics and/or diagnostics, and can send messages or signals associated with vehicle prognostics and/or diagnostics. Second element 208 also can send or transmit associated messages or signals 212. In various embodiments, the second element 208 can transmit the associated messages or signals 212 to VIM 302. Moreover, the second element 208 can translate or modify the received message or signal 212 into a format the VIM 302 can understand.

As will be described later, none, some, or all of the messages or signals received at first element 202 and/or at second element 208 may come from a trailer coupled to a vehicle. The messages or signals from the trailer may be from one or more subsystems, such as trailer ECUs or trailer sensor elements.

VMS 300 can be of any suitable configuration. In various embodiments, VMS can include vehicle information module (VIM) 302, external interface 306, and one or more configuration files 304 associated with the VIM 302.

The VIM 302 design can employ a loose-coupling and separation of concerns. Generally, the VIM 302 may have as its sole responsibility to reflect a current status of the system or vehicle it models. Thus, VIM 302 can be configurable. The configuration files 304 of the VIM 302 may be representative of system subsystems, ECUs, or other elements. For example, each configuration file 304 may represent a subsystem, ECU, or other element. Furthermore, in various embodiments, instead of changing a source code to add, change, or delete messages or data fields, configuration files 304, such as XML files, may be edited to configure or reconfigure the VIM 302. Thus, if a subsystem, ECU, or other system or vehicle element is modified, added, removed, or replaced, the XML file associated therewith may be changed. The configuration files, such as XML files, may be read to create a framework that the system or vehicle data will fill-in.

External interface 306 can be any suitable interface. Moreover, external interface 306 may be the only interface (or common) interface for clients 402, 404, 406, 408. External interface may provide access for various ones of the clients to system or vehicle data or information, such as system or vehicle status information or data. In various embodiments, external interface may be a VIM Service implemented as a webservice interface, for example, and it may be coupled to VIM 302 to receive system or vehicle information or data.

In various embodiments, clients can be added or removed during runtime of the system or vehicle. In addition, subscriptions may be initiated and cancelled by clients. As noted above, the VIM 302 is not concerned with who is interacting with it, only what data is needed or requested.

As noted above, FIG. 1 can represent a high-level architecture of the system and method according to embodiments of the present invention, including VIM 302 and the messaging and interaction between the CAN bus, prognostics, and end-user. Optionally, messages may be received directly from the J1939 CAN bus by a CAN bus manager, for example. The J1939 messages can be translated into a message format the VIM 302 understands. Optionally, the VIM 302 also may receive messages from prognostics sensors via Ethernet and prognostics module 208, for example. A vehicle may be defined through the use of XML files, for example, and subsystems and/or ECUs may be added, removed, or changed. In various embodiments, such additions, removals, or changes may be performed by modifying associated XML files. Optionally, such additions, removals, or changes may be completed by performing only a VIM restart.

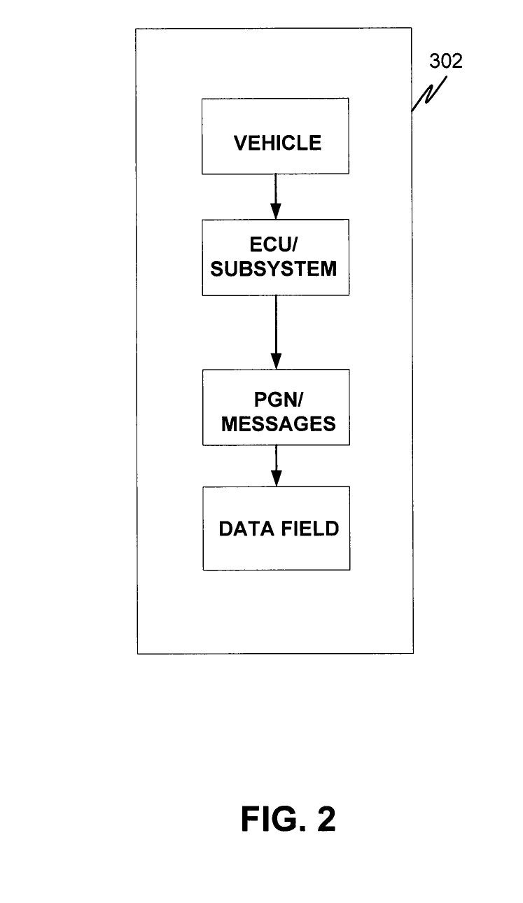

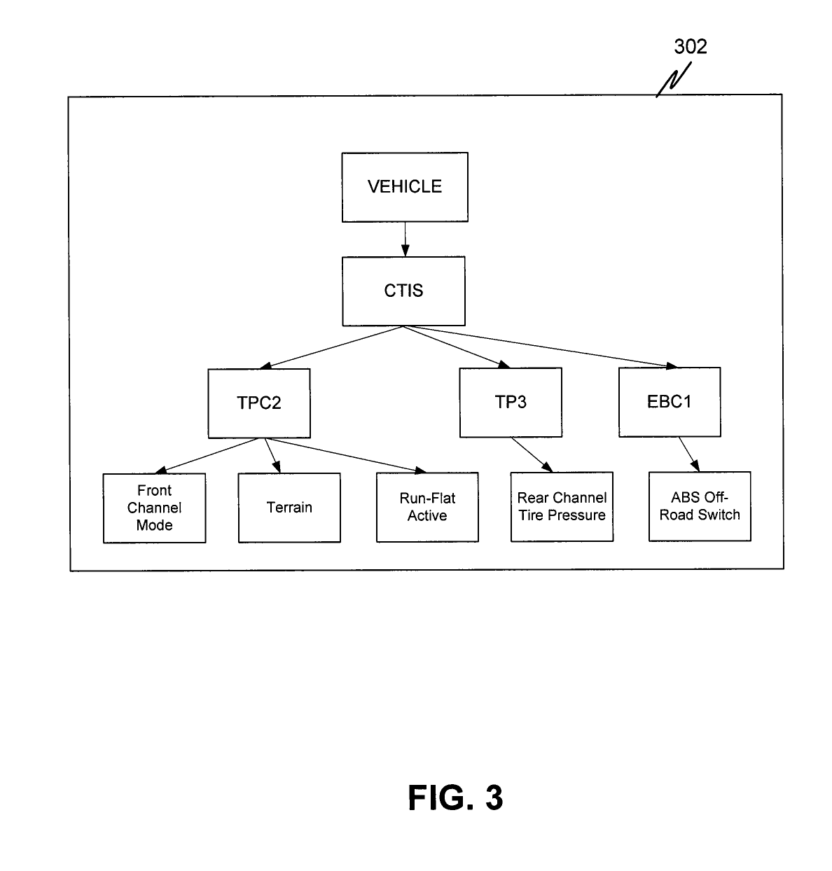

FIGS. 2 and 3 a block diagram illustrating a relationship of a subsystem configured in the vehicle information module (VIM) and a block diagram illustrating an exemplary relationship of a specific subsystem configured in the VIM, respectively. In relation to these figures, an actual vehicle (including a trailer) may house multiple subsystems or ECUs. Each subsystem or ECU can be configured in the VIM to have multiple messages and each message may contain one or more data fields. For example, FIG. 3 shows the VIM being configured with a central tire inflation system (CTIS) subsystem. The CTIS may have associated therewith a plurality of PGN/messages, such as TPC2, TP3, and EBC1. Each PGN/message can have associated therewith one or more data fields. For example, PGN/message TPC2 can have a front channel mode data field, a terrain data field (e.g., off-road, on-road, etc.), and a run-flat active data field (e.g., on or off). PGN/message TP3 may have a rear channel tire pressure data field and PGN/message EBC1 may have an ABS Off-road switch data field. Note that FIG. 3 is merely illustrative and the vehicle can have any suitable number or type of ECU/subsystem representations associated therewith, each ECU/subsystem representation can have any suitable number or type of PGN/messages associated therewith, and each PGN/message can have any suitable number or type of data fields associated therewith.

With reference to FIGS. 2 and 3, note that the VIM can receive messages from the CAN bus and/or Ethernet by way of transmitting portion 200, for example. In the VIM, a vehicle class can route the data to the proper subsystem. The subsystem can route to the proper message, and the message can trigger an even to tell the data field or fields within it to update. Updating can include each data field extracting its portion of the PGN/message (e.g., “terrain” data field in FIG. 3 will know to look at seventeenth bit, for example, and update itself).

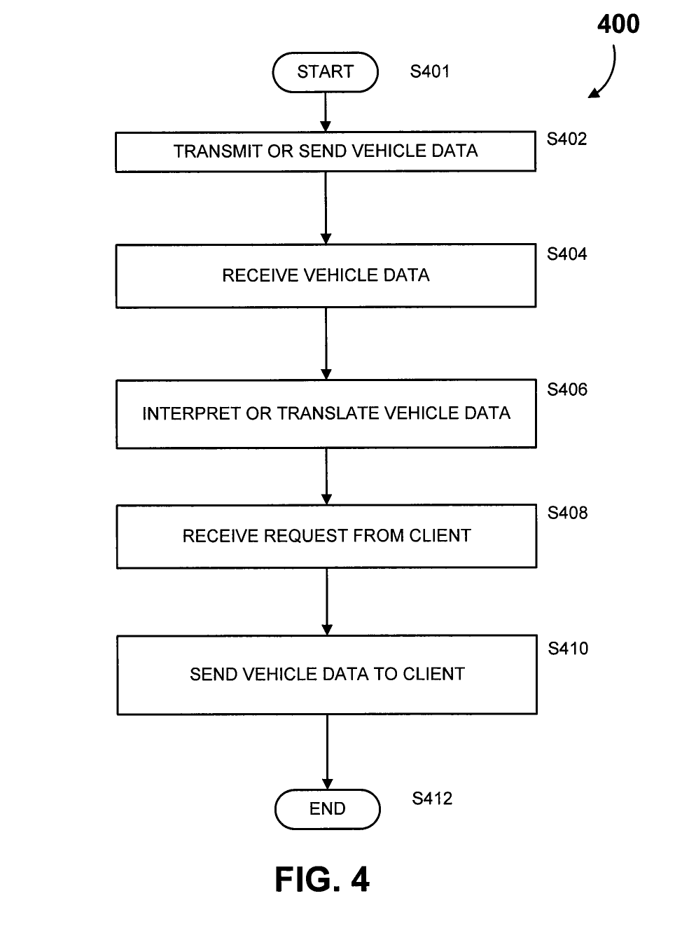

FIG. 4 is a flowchart of an exemplary method 400 according to various embodiments of the present invention. Method 400 can begin at S401 and proceed to any suitable step or operation. In various embodiments, method 400 may proceed to S402.

S402 can include transmitting or sending system or vehicle messages or signals. In various embodiments, such messages or signals may include vehicle data, such as vehicle status data. Furthermore, the messages or signals can be transmitted by vehicle ECUs or subsystems to an element that translates the messages into a format readable by the vehicle information module (VIM) 302. Optionally, the method can proceed to S404.

S404 can include receiving vehicle messages or signals including vehicle data. In various embodiments, the messages or signals may be received at the VIM 302 of the vehicle management system (VMS) 300. The messages or signals can be any suitable messages or signals and can include any suitable data. For example, the messages or signals may be associated with subsystems or electronic control units (ECUs). Moreover, the signals or messages can be transmitted by any suitable means. Messages or signals from ECUs, for example, may be transmitted via a CAN bus using J1939 protocol. Optionally, the method can proceed to S406.

S406 can include translating, modifying, or interpreting the received vehicle messages or signals into individual data fields, for example. In various embodiments, the translating or modifying may be performed by the VIM 302. Moreover, in various embodiments, the translating, modifying, or interpreting of messages or signals may be performed selectively. In various embodiments, the interpreting, modifying, or translating may be performed selectively based on a configuration of one or more eXtensible Markup Language (XML) files 304 of the VIM 302. Optionally, the method can proceed to S408.

S408 can include receiving a request from a client or end-user for system or vehicle data. In various embodiments, receiving the request may be for specific data. Furthermore, the specific data may be associated with a current status of the system or vehicle. Requests also may be periodic, based on either a change in data (e.g., change in the system's subsystem or ECU configuration) or based on a predetermined time period for requesting. The request may be received by external interface 306 and relayed to VIM 302. Optionally, the method can proceed to S410.

S410 can include sending to the client or end-user requested system or vehicle data or information. In various embodiments, the requested system or vehicle data can be sent via an external interface, such as a webservice interface. In various embodiments, the external interface is common to all clients or end-users. Optionally, the data can be sent to all clients or end-users in a same format.

After S410, the method may proceed to any suitable step or operation. In various embodiments, the method may proceed to S412 where the method ends.

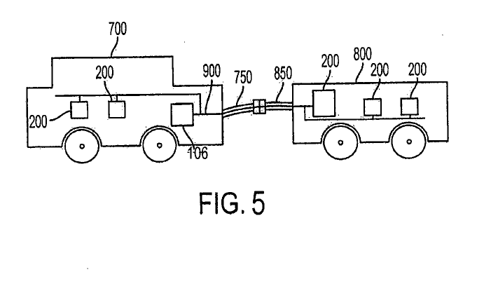

FIG. 5 is a block diagram representation of a vehicle 700 and trailer 800 according to various embodiments of the present invention. Note that the trailer 800 shown in FIG. 5 is for illustrative purposes, and the trailer 800 can be of any suitable configuration, of any suitable size, and for any suitable purpose or function. For example, though FIG. 5 shows the trailer 800 having two wheels in profile, the trailer can have any suitable number of wheels and any suitable number of axes.

The module and system and method thereof according to the present invention can be implemented in the vehicle 700, in the trailer 800, or in the vehicle-trailer combination. Thus, vehicle data, trailer data, or vehicle and trailer data or information may be sent or presented to one or more clients or end-users.

A vehicle information module (VIM) can be configured to interpret, store, and communicate to interested clients the status of vehicle 700 and/or trailer 800, similar to as discussed above for a system or vehicle only. Messages from subsystems or ECUs 200 of trailer 800 may be sent to VIM 300 of vehicle 700 by way of coupling elements 750 and 850. Coupling elements 750 and 850 may provide communications between the vehicle 700 and trailer 800 by way of a CAN bus 900 and CAN bus bridge. Though not shown in FIG. 5, alternatively, trailer 800 may have its own separate VIM, and the VIM can receive and transmit requested trailer and/or vehicle data or information to end-users. Also similar to above, interested clients or end-users may include a GUI, a database, an Interrogative Diagnostics & Prognostics System and other future stakeholders, such as a fleet management system, a logistics system, a maintenance system, and a mobile personal digital assistant.

It should be appreciated that any steps described above may be repeated in whole or in part in order to perform a contemplated providing or presenting data task. Further, it should be appreciated that the steps mentioned above may be performed on a single or distributed processor. Also, the processes, elements, components, modules, and units described in the various figures of the embodiments above may be distributed across multiple computers or systems or may be co-located in a single processor or system.

Embodiments of the method, system and computer program product (i.e., software) for providing or presenting data, may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic device such as a PLD, PLA, FPGA, PAL, or the like. In general, any process capable of implementing the functions or steps described herein can be used to implement embodiments of the method, system, or computer program product for providing or presenting data.

Furthermore, embodiments of the disclosed method, system, and computer program product for providing or presenting data may be readily implemented, fully or partially, in software using, for example, object or object-oriented software development environments that provide portable source code that can be used on a variety of computer platforms. Alternatively, embodiments of the disclosed method, system, and computer program product for providing or presenting data can be implemented partially or fully in hardware using, for example, standard logic circuits or a VLSI design. Other hardware or software can be used to implement embodiments depending on the speed and/or efficiency requirements of the systems, the particular function, and/or a particular software or hardware system, microprocessor, or microcomputer system being utilized. Embodiments of the method, system, and computer program product for providing or presenting data can be implemented in hardware and/or software using any known or later developed systems or structures, devices and/or software by those of ordinary skill in the applicable art from the functional description provided herein and with a general basic knowledge of the computer arts.

Moreover, embodiments of the disclosed method, system, and computer program product for providing or presenting data can be implemented in software executed on a programmed general-purpose computer, a special purpose computer, a microprocessor, or the like. Also, the providing or presenting data systems and methods can be implemented as a program embedded on a personal computer such as a JAVA® or CGI script, as a resource residing on a server or graphics workstation, as a routine embedded in a dedicated processing system, or the like. The methods and systems can also be implemented by physically incorporating the methods for providing or presenting data into a software and/or hardware system, for example a computer software program.

It is, therefore, apparent that there is provided in accordance with the present invention, a method, system, and computer program product for providing or presenting data. While this invention has been described in conjunction with a number of embodiments, it is evident that many alternatives, modifications and variations would be or are apparent to those of ordinary skill in the applicable arts. Accordingly, applicant intends to embrace all such alternatives, modifications, equivalents and variations that are within the spirit and scope of this invention.

What is claimed is:

1. A method for presenting vehicle data of a wheeled tactical vehicle and trailer combination vehicle to a client using a vehicle information module of a vehicle management system, the vehicle information module being configurable through a series of eXtensible Markup Language (XML) files, the XML files defining device addresses, messages, and desired fields, and the method comprising:
receiving at the vehicle information module of the vehicle management system, vehicle messages including vehicle data and trailer data;
selectively translating the received vehicle messages and the trailer messages into individual data fields using the vehicle information module;
receiving a request from a client for vehicle or trailer data, the requested vehicle or trailer data including data representing a status of the wheeled tactical vehicle or a status of the trailer;
sending to the client requested vehicle data or the trailer data based on said receiving the request, said sending being via a webservice interface,
wherein said selective translating being based on the desired fields specified in the XML files, and said selective translating being performed such that only vehicle or trailer messages necessary to populate the desired fields specified in the XML files are translated.

2. The method of claim 1,
wherein the vehicle information module is configurable such that modification of addresses, messages, or data fields in response to a change in the wheeled tactical vehicle's physical configuration is performed through modification of the XML files, and
wherein the XML files of the vehicle information module are not recompiled in response to the change or modification.

3. The method of claim 1, wherein said receiving at the vehicle information module includes receiving vehicle data sent from a vehicle sensor.

4. The method of claim 1, wherein the vehicle messages include messages from separate sources including a first source and a second source, the first source being via a controller area network (CAN) bus and the second source being via Ethernet.

5. The method of claim 4, wherein messages from the Ethernet include vehicle prognostics data.

6. The method of claim 1, wherein the client is one of a graphical user interface, a database, an Interrogative Diagnostics and Prognostics system, a fleet management system, a logistics system, a maintenance system, and a mobile personal display device.

7. A system for presenting specific vehicle and trailer data to a client upon request, the system comprising:
means for receiving a first message signal including a trailer status information, the first message signal being in a first data format;
means for receiving a second message signal including trailer status information, the second message signal being in a second data format, the second data format being different from the first data format;
means for translating the first message in the first format to a third data format;
means for translating the second message in the second format to the third data format;
means for receiving a request for trailer status information; and
means for transmitting only requested trailer status information, the transmitted trailer status information being transmitted in the third data format.

8. The system of claim 7,
wherein the first data format is associated with a trailer bus, and
wherein the second data format is associated with a prognostics-specific format.

9. The system of claim 8, wherein the trailer bus is a CAN bus.

10. The system of claim 7,
wherein said means for translating the first message in the first format to the third data format selectively translates the first message based on a configuration of one or more eXtensible Markup Language (XML) files, the selective translating being done such that only first message data necessary to populate desired fields specified in the XML files are translated, and
wherein said means for translating the second message in the second format to the third data format selectively translates the second message based on the configuration of the one or more XML files, the selective translating being done such that only second message data necessary to populate desired fields specified in the XML files are translated.

11. The system of claim 7, wherein the request for trailer status information is from one of a graphical user interface, a database, an Interrogative Diagnostics and Prognostics system, a fleet management system, a logistics system, a maintenance system, and a mobile personal display device.

12. A method for providing specific data to an end-user, the method comprising:
selectively interpreting received messages associated with a complex system, said selectively interpreting being based on a configuration of one or more eXtensible Markup Language (XML) files, the XML files being reconfigurable based on a physical change made to the complex system;
receiving a request from an end-user for specific data, the specific data being associated with a current status of the complex system; and
sending to the end-user only the requested data in response to the received request,
wherein the end-user is one of a graphical user interface, a database, an Interrogative Diagnostics and Prognostics system, a fleet management system, a logistics system, a maintenance system, and a mobile personal display device.

13. The method of claim 12, wherein the complex system is a wheeled trailer, and the messages associated with the wheeled trailer include CAN bus messages.

14. The method of claim 12, wherein said sending only the requested data is performed periodically.

15. The method of claim 12, wherein said sending only the requested data is performed based on changing data.

16. The method of claim 12, wherein the complex system is a vehicle and a trailer.

17. The method of claim 12, wherein the complex system is a tactical wheeled vehicle and trailer combination.

18. The method of claim 12, wherein the complex system is a helicopter.

19. The method of claim 12, wherein the complex system is a networked computer system.

20. The method of claim 12,
wherein the one or more eXtensible Markup Language (XML) files respectively represent an electronic control unit (ECU) of the complex system, and
wherein the one or more XML files are configured to represent a current state of the complex system.
